(19) United States
(12) Patent Application Publication
(10) Pub. No.: US 2016/0183521 A1
(43) Pub. Date: Jun. 30, 2016

(54) Solvent Free Liquid Alkylbenzene Sulfonate Composition and Its Use in Agrochemical Formulations

(71) Applicant: AKZO NOBEL CHEMICALS INTERNATIONAL B.V., Amersfoort (NL)

(72) Inventors: Shawn Zhu, Stormville, NY (US); Joshua Lewis Jurs, New Fairfield, CT (US); Michael Walters, Rhinebeck, NY (US)

(21) Appl. No.: 14/907,004

(22) PCT Filed: Jul. 28, 2014
(86) PCT No.: PCT/EP2014/066122

§ 371 Date: Jan. 22, 2016

Related U.S. Application Data
(60) Provisional application No. 61/860,373, filed on Jul. 31, 2013.

(30) Foreign Application Priority Data
Nov. 15, 2013 (EP) 13193008.3

(51) Int. Cl. A01N 25/30; A01N 37/38

(52) U.S. Cl. CPC A01N 25/30; A01N 37/38

(57) ABSTRACT

A liquid alkylbenzene sulfonate composition comprising a salt of alkylbenzene sulfonate (preferably a calcium or DMAPA salt) and a liquid alcohol alkoxylate is disclosed. This composition is useful as an emulsifier. It is solvent-free and non-flammable and has low odor.

### FIELD OF THE INVENTION

The present invention is directed to a liquid alkylbenzene sulfonate composition comprising a salt of alkylbenzene sulfonate and a liquid alcohol alkoxylate. The invention also related to the use of said composition as an emulsifier.

### BACKGROUND OF INVENTION

Almost all liquid pesticide formulations contain a package of emulsifiers when the pesticide is a hydrophobic substance. This is because the hydrophobic pesticide does not mix well with water and water is the most common carrier medium to dilute the pesticide formulations during application. The emulsifiers help bring together the hydrophobic pesticide and water to form kinetically stable emulsions or thermodynamically stable microemulsions that can be sprayed. The phenomenon of forming the emulsions and microemulsions is called emulsification. Typical emulsifier blends comprise a blend of anionic surfactant, a nonionic surfactant, and a block copolymer, each is typically produced individually. In most formulations, the anionic surfactant in the blends of emulsifiers is a salt of alkylbenzene sulfonate. It is well known to the skilled in the art that when the salt is a calcium salt, the alkylbenzene sulfonate is most effective in terms of emulsification power. Most popular calcium alkylbenzene sulfonate is calcium dodecylbenzene sulfonate (Ca-DDBS) and it can be made by neutralizing two moles of DDBS acid with one mole calcium oxide (or calcium hydroxide) in various inert solvents. Inert solvent is necessary to reduce the viscosity of Ca-DDBS. Without the solvent, Ca-DDBS is very difficult to handle due to its high viscosity. The amount of solvent required to dilute Ca-DDBS into a handlable product is about 40-45 wt %. That is, the concentration of Ca-DDBS is about 55-60 wt %, which is the most common concentration used in the industry.

Another less popular salt of alkylbenzene sulfonate is the dimethylamidopropylamine (DMAPA) salt. Similarly, DMAPA-DDBS requires ˜40% solvents to reduce its viscosity to make it easy to handle.

The solvents, or diluents, commonly used to dilute Ca-DDBS (or DMAPA-DDBS) emulsifier are listed in Table 1:

TABLE 1
Solvents commonly used to dilute Ca-DDBS emulsifier

| Common Solvents | | | |
|---|---|---|---|
| used in Ca-DDBS | Flammability | Odor | Toxicity |
| Methanol | Flammable | Strong | May cause blindness |
| | | | if consumed |
| Isopropyl alcohol | Flammable | Strong | |
| Iso-butanol | Flammable | Strong | Potentially repro toxic |
| Hexanol | Flammable | Strong | |
| 2-ethyhexanol | | Strong | |
| Aromatic solvents | Some are | Strong | Contains trace amount |
| | flammable | | of naphthalene |
| Propylene glycol | Non- | None | None |
| or other glycols | flammable | | |

As it is shown in the above table, all solvents except glycols have issues either with flammability, odor, and/or toxicity. In addition, all solvents, including glycols, serve only one function—to make the DDBS salts less viscous so that they can be handled easily.

Solvents are used in various pesticide formulations including emulsifiable concentrate (EC), microemulsion (ME), and suspoemulsion (SE). For example, EC formulations of 4 lbs/gallon 2,4-D ester containing solvents have been in the market for many years. The solvents may come from the DDBS salt or it may be added during preparation of the EC. Nowadays, use of solvents in pesticide formulations is becoming an issue due to environmental concerns. Because of that, 6 lb/gallon 2,4-D ester EC has appeared in the market place recently. Since 2,4-D ester itself is a liquid with quite low viscosity, this 6 lbs/gal 2,4-D EC can be formulated with only 2,4-D ester and emulsifiers without the need for additional solvents. However, the current 6 lbs/gal 2,4-D can't be claimed as solvent-free because some solvent is presented in the emulsifier blend which contains Ca-DDBS (or DMAPA-DDBS) with solvents. It would have market advantage for a manufacturer if a 6 lbs/gal 2,4-D EC can be claimed as solvent-free.

Therefore, there is a need to have a solvent-free, non-flammable, and low odor Ca-DDBS and DMAPA-DDBS in the market place.

The present inventors have addressed this need by introducing a liquid alkylbenzene sulfonate composition comprising a Ca (or DMAPA) alkylbenzene sulfonate and a liquid alcohol alkoxylate.

Berol® 9927, manufactured by AkzoNobel, contains Ca-DDBS, a solid alcohol alkoxylate, and butanol. However, the presence of butanol makes it flammable (flash point ˜45° C.).

US20070191229A1 discloses a so-called solventless herbicide composition, triclopyr butoxyethyl ester EC. Only one surfactant mixture is disclosed in this article as disclosed in example 1. The surfactant mixture of this article contains 50% Agnique ABS 60C, a 60% Ca-DDBS in 2-Ethyhexanol solvent. Therefore, this so-called solventless herbicide composition claimed in this article is not truly solvent-free.

Similarly, WO 2007/095163, which relates to an emulsifying system and adjuvant for formulating water soluble or water emulsifiable pesticide formulations, does not disclose any blends that are solvent-free. WO 2007/095163 considers water and lower alcohol as non-solvents. Further, all of the examples in WO 2007/095163 contains significant amount of solvent because Agnique ABS 60C is 60% Ca-DDBS in 40% 2-ethylhexyl alcohol.

### SUMMARY OF THE INVENTION

The invention relates to a liquid alkylbenzene sulfonate composition comprising at least one alkylbenzene sulfonate salt selected from a calcium salt, a DMAPA salt, an ethanolamine salt, a diethanolamine salt, a triethanolamine salt, a diethylenetriamine salt, or an ethylenediamine salt of alkylbenzene sulfonate, and a liquid alcohol alkoxylate.

In one embodiment the alkyl group in the alkylbenzene sulfonate of the present invention comprises 10-20 carbon atoms; in another embodiment 12-14 carbon atoms, wherein said alkyl groups can be linear or branched, saturated or non-saturated, and optionally substituted. The concentration of alkylbenzene sulfonate salt in the liquid alkylbenzene sulfonate composition of the invention is, in one embodiment from about 40-70 wt %, in another embodiment from about 50-65 wt %, and yet another embodiment from about 55-60 wt %.

The liquid alcohol alkoxylate in the novel liquid alkylbenzene sulfonate composition has the following general structure:

R—O(AO)ₙ—H

Wherein R is C6-C12, in another embodiment a C8-C10, linear or branched, hydro carbon chain; A is an ethylene or branched propylene group, preferably an ethylene group; n is from 1-8, in another embodiment from 2-7, in another embodiment from 3-5. The concentration of the liquid alcohol alkoxylate in the liquid alkylbenzene sulfonate composition of the invention is from about 60-30 wt %, in another embodiment from about 50-35 wt %, and in yet another embodiment from about 45-40 wt %.

### DETAILED DESCRIPTION

The present invention employs a method to turn a very viscous DDBS salt into a handlable liquid alkylbenzene sulfonate composition without using a solvent or a diluent. The liquid alkylbenzene sulfonate composition of the invention comprises at least one alkylbenzene sulfonate salt selected from a calcium salt, a DMAPA salt, an ethanolamine salt, a diethanolamine salt, a triethanolamine salt, a diethylenetriamine salt, or an ethylenediamine salt and a liquid alcohol alkoxylate. Preferably the alkylbenzene sulfonate salt is a calcium salt. The composition of the invention is useful as an emulsifier, or as part of an emulsifier blend. The composition is a liquid and it is solvent-free and non-flammable. It preferably is a clear liquid with reduced odor. A solvent-free product is herein defined as a product with less than about 3 wt % solvents, in one embodiment less than about 2 wt % solvents, in another embodiment less than about 1 wt % solvents, in yet another embodiment less than about 0.5 wt % solvents. As used herein, the term “solvents” means a low viscosity liquid substances, not including water. The term also does not include surfactants even though surfactants may be used to dissolve other chemicals, as disclosed herein. Examples of solvents are methanol, isopropyl alcohol, iso-butanol, hexanol, 2-ethyhexanol, aromatic solvents, propylene glycol or other glycols (such as polyethylene glycol), glycerine, ester of fatty acid, vegetable oil, alcohol, propylene carbonate, glycerine carbonate, mineral oil, hydrocarbons (e.g., octane), N-Methylpyrrolidone (NMP), amides (e.g, alkyl dimethyl amide), etc.

The alkyl chain in alkylbenzene sulfonate of the present invention is C10-C20, in another embodiment C10-C18, and in yet another embodiment a C12-C14, linear or branched, saturated or non-saturated, hydrocarbon chain. In another embodiment of the invention the alkyl chain in alkylbenzene sulfonate is a dodecyl chain. The concentration of alkylbenzene sulfonate salt in the composition of the invention is generally from about 40-70 wt %, in another embodiment from about, 50-65 wt %, and still another embodiment from about 55-60 wt %. Preferably the rest of the component amounting to 100% is a liquid alcohol alkoxylate.

The liquid alcohol alkoxylate of the present invention has the following general structure:

R—O(AO)ₙ—H

Wherein R is C6-C12, linear or branched, hydro carbon chain; A is an ethylene or branched propylene group; n is from 1-8, in another embodiment from 2-7, and in yet another embodiment from 3-5. It is understood that n is the average degree of alkoxylation. The degree of alkoxylation reflects the moles of alkyleneoxide reacted with one mole of alcohol (the R—OH). The concentration of the liquid alcohol alkoxylate in the composition of the invention is from about 60-30 wt %, in another embodiment from about 50-35 wt %, and in another embodiment from about 45-40 wt %. In one embodiment R is a branched C8-10 alcohol alkoxylate. In yet another embodiment R is 2-ethylhexanol (2-EH) with 2-6 EO or 2-propylhapanol (2-PH) with 2-6EO. In still another embodiment R is 2-EH with 3-5EO.

The liquid alkylbenzene sulfonate composition of the invention may contain a small amount of additives. The term additives used in the specification refer to additional chemicals which are not already present in the alkylbenzene sulfonate salt and liquid alcohol alkoxylate. These additives do not affect the handling of the composition according to the present invention. Such additives include, for example, methanol, butanol, isopropyl alcohol, ethanol, glycols, aromatic solvents, and water. The amount of the additives is preferably less than 5 wt %, in another embodiment less than 3 wt %, in another embodiment less than 2 wt %; in another embodiment less than 1 wt % and in another embodiment zero.

The liquid alkylbenzene sulfonate composition of the present invention may be used alone, though not common, in certain oily liquid pesticide formulations depending on the hydrophilic-lipophilic balance (HLB) characteristic of the medium. However, it is preferred to use the liquid alkylbenzene sulfonate composition together with a high HLB nonionic surfactant such as a castor oil ethoxylate with 36EO (example of castor oil ethoxylate is Emulpon® CO-360 manufactured by AkzoNobel)) and/or a high HLB EO-PO block copolymer (example of a EO-PO block copolymer is Ethylan® NS-500LQ manufactured by AkzoNobel). When it is used together with other emulsifiers, it is typically used at more than 20%, preferably more than 40%, and more preferably more than 50% in the total emulsifier package. The liquid alkylbenzene sulfonate composition of the present invention is useful for oily agro chemical formulations. Particularly useful oily agro chemical formulations are pesticide formulations. Particularly useful pesticides are (1) herbicides: 2,4-D ester, dicamba ester, MCPA ester, propanil, clethedim, cyhalofop, acetochlor, alachlor, and butochlor; and (2) insecticides: cyholothrin, pyrethrins, methprene and pyrethroids such as bifenthrin, permethrin, and cypermethrin. Typically the total concentration of all emulsifiers in the oily agro chemical formulations is less than 20%, more commonly less than 10%.

The present inventors have discovered that not all liquid surfactants are suitable for this invention. In order to form a flowable and non-flammable liquid alkylbenzene sulfonate, the liquid surfactants must have a low viscosity, low melting point, and high flash point with reduced odor. As it is well known in the art that an alcohol is not a surfactant while an ethoxylated alcohol is a surfactant, depending on the chain length of the alcohol and the extent of the ethoxylation. For example, when carbon chain length is 4 or shorter, the alcohol ethoxylate is not a surfactant because it does not form microstructures such as micelle, microemulsion, or liquid crystal in water. When an odorous alcohol is turned into an alkoxylated alcohol, the odor is reduced significantly.

The present invention pertains to:

1. A solvent-free emulsifier composition comprising at least one liquid salt of alkylbenzene sulfonate and a liquid alcohol alkoxylate, wherein the alkyl group in the alkylbenzene sulfonate is C10-C20, linear or branched, saturate or non-saturated, substituted or non-substituted hydrocarbon group; and wherein the liquid alcohol alkoxylate has the following structure:

R—O(AO)ₙ—H

wherein R is C6-C12, linear or branched, hydrocarbon group, A is an ethylene or branched propylene group and n is from 1-8. The alkylbenzene sulfonate salt may be selected from a calcium salt, dimethylamidopropylamine salt, an ethanolamine salt, a diethanolamine salt, a triethanolamine salt, a diethylenetriamine salt, a ethylenediamine salt of alkylbenzene sulfonate. The alkyl group in the alkylbenzene sulfonate may be C12-C14 linear or branched, saturate or non-saturated, substituted or non-substituted hydrocarbon group. In one embodiment, the liquid alcohol alkoxylate has the following structure:

R—O(CH2-CH2O)ₙ—H

wherein R is C6-C10, linear or branched, hydrocarbon chain, and n is from 1-8. In another embodiment, the R is a branched C8-C10 alkyl group and n is from 3-5. Additional additives in the composition are present in a concentration of less than 2% by weight. In one embodiment, the composition is essentially free of additional additives. The concentration of the alkylbenzene sulfonate salt is from about 40-70 wt %, in another embodiment, from about 50-65 wt %, in yet another embodiment, from about 55-60 wt %. The concentration of the liquid alcohol alkoxylate in the composition is from about 60-30 wt %, in another embodiment, from about 50-35 wt %, in yet another embodiment, from about 45-40 wt %. In one embodiment, the composition comprises 55-65 wt % of calcium dodecylbenzene sulfonate and 35-45% of 2-ethylhexanol with 3-5EO.
2. A solvent-free emulsifier composition comprising from about 55-65 wt % of a liquid salt of alkylbenzene sulfonate and 35-45% of liquid alcohol alkoxylate, wherein the alkyl group in the alkylbenzene sulfonate is a dodecyl group and wherein the liquid alcohol alkoxylate has the following structure:

R—O(AO)ₙ—H

wherein R is a 2-ethylhexyl group and the n is 3-5. In one embodiment, the liquid salt of alkylbenzene sulfonate in the composition is from about 55-60 wt % and the liquid alcohol alkoxylated in the composition is 40-45%.
3. An oily liquid agricultural formulation comprising at least one agrochemical active and an effective amount of the solvent free emulsifier composition of 1 (above). The solvent free emulsifier composition of 1 may be in the oily liquid agricultural formulation at an amount of 1-10 wt % based on total weight of agricultural formulation. The agrochemical active may be a pesticide, herbicide, fungicide or mixtures thereof, in one embodiment, the agrochemical active is a herbicide. The herbicide may be selected from 2,4-D ester, dicamba ester, MCPA ester or a mixture thereof. The pesticide may be selected from permethrin, methoprin, or a mixture thereof.
4. A herbicidal formulation comprising at least one herbicidally active ingredient and an effective amount of the solvent free emulsifier composition comprising about 55-60 wt % of a liquid salt of alkylbenzene sulfonate and 40-45% of a liquid alcohol alkoxylate, wherein the alkyl group in the alkylbenzene sulfonate is a dodecyl group and wherein the liquid alcohol alkoxylate has the following structure:

R—O(AO)ₙ—H

wherein R is a 2-ethylhexyl group and the n is 3-5. The herbicidally active ingredient may be selected from 2,4-D ester, dicamba ester, MCPA ester or a mixture thereof.
5. A method of reducing the viscosity of a viscous alkylbenzene sulfonate salt in the absence of a solvent or a diluent wherein the method comprises mixing the alkylbenzene sulfonate salt with an effective amount of a liquid alcohol alkoxylate. In one embodiment, the liquid salt of alkylbenzene sulfonate is calcium or dimethylamidopropylamine salt of alkylbenzene sulfonate. In another embodiment, the alkyl group in the alkylbenzene sulfonate is C12-C14 linear or branched, saturated or non-saturated, substituted or non-substituted hydrocarbon group. In yet another embodiment, the liquid alcohol alkoxylate has the following structure:

R—O(CH2-CH2O)ₙ—H

wherein R is C6-C10, linear or branched, hydrocarbon chain, and n is from 1-8. R, in one embodiment, is a branched C8-C10 alkyl group and n is from 3-5. The composition may be essentially free of additional additives. In one embodiment, the concentration of the alkylbenzene sulfonate salt is from about 40-70 wt %, in another embodiment, from about 55-60 wt %, in yet another embodiment, from about 60-30 wt %.

The invention will now be illustrated by the following non-limiting examples.

### Example 1

### Making Concentrated Ca-DDBS in a Liquid Alcohol Alkoxylate, 2-Ethylhexanol-4EO (2-EH-4EO) Surfactant

A. To a 1 L round bottom flask equipped with an over head stirrer, addition funnel, reflux condenser and thermocouple was added CaO (21.4 g) and methanol (100 g).
B. The Witconic 1298H branched DDBS acid (248 g) is dissolved in methanol (301 g) and then added to the addition funnel.
C. The Witconic 1298H /methanol solution is added drop-wise to a vigorously stirred reaction slurry. The addition of the acid to the CaO/methanol reaction slurry is exothermic so cooling is applied to keep the temperature <65° C. (See reaction scheme 1).

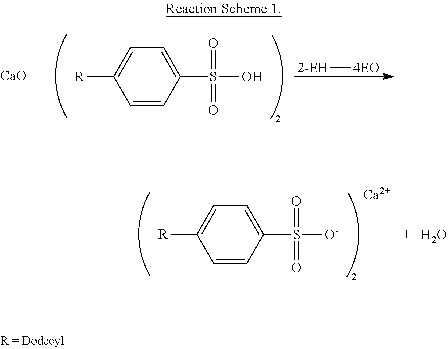

D. Once all of the Witconic 1298H /methanol solution is added to the reaction mixture the temperature is maintained at 60° C. for 1-2 hours to continue to digest.
E. After an hour the mixture is cooled and the solids are allowed to settle by centrifuge. The Ca-DDBS/Methanol liquid mixture is then decanted (or filtered) away from the solids (mostly CaSO2).
F. The Ca-DDBS/Methanol liquid is mixed with the 2-EH-4EO surfactant in the proper ratio to give the desired activity (˜57 wt % in this example) and then added to a flask for removal of the methanol.
G. The methanol is then removed under a reduced atmosphere with the aid of a rotary evaporator until the methanol is completely gone. The sample is a clear, flowable liquid with a % active of ˜57% Ca-DDBS and ˜43% 2-EH-4EO surfactant. The pH of a 5% sample in 25% IPA aqueous solution is ˜7.5.

### Example 2

Emulsification performance of Ca-DDBS sample prepared in example 1 is compared with Witconate P-1220EH (˜60% Ca-DDBS+˜40% 2-EH alcohol) in various hydrophobic substances. Since the % active of the main component, Ca-DDBS, is about the same, the difference between these two samples is in the other component, one with 2-EH-4EO (a surfactant with a reduced odor) and the other with 2-EH (not a surfactant and with a strong odor).

Procedure:
A. Prepare a sample of 90% hydrophobic substance+10% Ca-DDBS blend. This is called sample A.
B. Add 5% sample A into 95% water with 1000 hardness. This is called sample B.
C. Shake sample B. This is called emulsion.
D. Observe emulsion appearance with eyes. Take a picture.

The results are tabulated in Table 2.

TABLE 2
Emulsion comparison between Ca-DDBS/2-EH-4EO and
Witconate P-1220EH

| Sample | | Hydrophobic | Emulsion |
|---|---|---|---|
| # | Emulsifier | substance | Comparison |
| 1 | Witconate P-1220EH | Soy methyl ester | |
| 2 | 57% Ca-DDBS in | Soy methyl ester | Milkier than |
| | 2-EH-4EO | | Sample #1 |
| 3 | Witconate P-1220EH | Exxsol 110 | |
| 4 | 57% Ca-DDBS in | Exxsol 110 | Milkier than |
| | 2-EH-4EO | | Sample #3 |
| 5 | Witconate P-1220EH | Isopar L | |
| 6 | 57% Ca-DDBS in | lsopar L | Milkier than |
| | 2-EH-4EO | | Sample #5 |
| 7 | Witconate P-1220EH | Aromatic 150 | |
| 8 | 57% Ca-DDBS in | Aromatic 150 | Milkier than |
| | 2-EH-4EO | | Sample #7 |
| 9 | Witconate P-1220EH | Soybean oil | |
| 10 | 57% Ca-DDBS in | Soybean oil | Milkier than |
| | 2-EH-4EO | | Sample #9 |

In the emulsification test, a milkier emulsion signals a better emulsion. It can be seen from the result in Table 2 that in all the systems, Ca-DDBS with 2-EH-4EO is better than Ca-DDBS with 2-EH.

### Example 3

| | | EC #1, | EC #2, |
|---|---|---|---|
| | | wt % | wt % |
| 2,4-D Octyl ester | | 93 | 93 |
| 57% Ca-DDBS in | | | 3.85 |
| 2-EH-4EO | | | |
| Emulpon NS-500LQ | Butyl alcohol EO-PO | 3.89 | 1.75 |
| | block copolymer | | |
| Emulpon CO-360 | Castor oil ethoxylate | 3.11 | 1.4 |
| | (36EO) | | |
| Bloom | | Poor | Excellent |
| Emulsion sediment | | Crashed | Excellent |
| after 2 hours | | emulsion | (No |
| | | | sediment) |

EC #1 doesn't contain the Ca-DDBS (57% in 43% 2-EH-4EO) and its performance is very poor.
EC #2 contains Ca-DDBS (57% in 43% 2-EH-4EO) and it has excellent emulsification performance (excellent bloom and no sediment) in soft water (34 ppm), 342 ppm, and 1000 ppm water.

### Example 4

### Making Concentrated DMAPA-DDBS in a Liquid Alcohol Alkoxylate, 2-Ethylhexanol-4EO (2-EH-4EO) Surfactant

To make DMAPA-DDBS in 2-EH-4EO: Add 51.7% Witconic 1298H (branched DDBS acid) into a container, add 40% 2-EH-4EO, mix well. Then add 8.3% DMAPA (dimethylamidopropylamine), mix well. The system becomes warm due to acid-base neutralization. A clear, low viscosity sample is obtained.

### Example 5

### Making Concentrated Ethylene Diamine-DDBS (EDA-DBBS) in a Liquid Alcohol Alkoxylate, 2-Ethylhexanol-4EO (2-EH-4EO) Surfactant

To make EDA-DDBS in 2-EH-4EO: Add 53.4% Witconic 1298H (branched DDBS acid) into a container, add 40% 2-EH-4EO, mix well. Then add 6.6% EDA (ethylene diamine), mix well. The system becomes warm due to acid-base neutralization. A clear, low viscosity sample is obtained.

1. An emulsifier composition comprising at least one liquid salt of alkylbenzene sulfonate and a liquid alcohol alkoxylate, wherein the emulsifier composition comprises less than 3 wt % of solvents selected from the group consisting of methanol, isopropyl alcohol, iso-butanol, 5 hexanol, 2-ethyhexanol, aromatic solvents, propylene glycol, polyethylene glycol, glycerine, ester of fatty acid, vegetable oil, alcohol, propylene carbonate, glycerine carbonate, mineral oil, hydrocarbons, N-Methylpyrrolidone (NMP), amides and combinations thereof, wherein the alkyl group in the alkylbenzene sulfonate is C10-C20, linear or branched, saturate or non-saturated, substituted or non-substituted hydrocarbon group, and wherein the liquid 10 alcohol alkoxylate has the following structure:
R—O(AO)ₙ—H
wherein R is C6-C12, linear or branched, hydrocarbon group, A is an ethylene or branched propylene group and n is from 1-8.

2. The composition of claim 1 wherein said alkylbenzene sulfonate salt is selected from a calcium salt, dimethylamidopropylamine salt, an ethanolamine salt, a diethanolamine salt, a triethanolamine salt, a diethylenetriamine salt, a ethylenediamine salt of alkylbenzene sulfonate.

3. The composition of claim 1 wherein the alkyl group in the alkylbenzene sulfonate is C12-C14 linear or branched, saturate or non-saturated, substituted or non-substituted hydrocarbon group.

4. The composition of claim 1 wherein the liquid alcohol alkoxylate has the following structure:
R—O(CH2-CH2-O)ₙ—H
wherein R is C6-C10, linear or branched, hydrocarbon chain, for example, a branched C8-C10 alkyl group, and n is from 1-8, for example 3-5.

5. The composition of claim 1 wherein additives in said composition are present in a concentration of less than 2% by weight, for example, wherein the composition is essentially free of additives.

6. The composition of claim 1 wherein the concentration of the alkylbenzene sulfonate salt is from about 40-70 wt %, for example from about 50-65 wt % or from about 55-60 wt %, and/or wherein the concentration of the liquid alcohol alkoxylate in the composition is from about 60-30 wt %, for example from about 50-35 wt % or from about 45-40 wt %.

7. The composition of claim 1 wherein the concentration of the liquid salt of alkylbenzene sulfonate is from about 55-65 wt %, for example, from about 55-60 wt %, and the concentration of the liquid alcohol alkoxylate is 35-45%, for example 40-45%, the alkyl group in the alkylbenzene sulfonate is a dodecyl group, and the liquid alcohol alkoxylate has the following structure:
R—O(AO)ₙ—H
wherein R is a 2-ethylhexyl group and the n is 3-5.

8. The composition of claim 1 wherein the composition which comprises 55-65 wt % of calcium dodecylbenzene sulfonate and 35-45% of 2-ethylhexanol with 3-5EO.

9. An oily liquid agricultural formulation comprising at least one agrochemical active, for example a pesticide, herbicide, fungicide or mixtures thereof, and an effective amount, for example 1-10 wt % based on total weight of agricultural formulation, of the emulsifier composition of claim 1, wherein the agricultural composition comprises less than 0.6 wt % of solvents selected from the group consisting of methanol, isopropyl alcohol, iso-butanol, hexanol, 2-ethyhexanol, aromatic solvents, propylene glycol, polyethylene glycol, glycerine, ester of fatty acid, vegetable oil, alcohol, propylene carbonate, glycerine carbonate, mineral oil, hydrocarbons, N-Methylpyrrolidone (NMP), amides and combinations thereof.

10. The formulation of claim 9 wherein said herbicide is selected from 2,4-D ester, dicamba ester, MCPA ester or a mixture thereof or wherein said pesticide is selected from permethrin, methoprin, or a mixture thereof.

11. A herbicidal formulation consisting of at least one herbicidally active ingredient and an effective amount of the composition of claim 1.

12. A method of reducing the viscosity of a viscous alkylbenzene sulfonate salt comprising less than 3 wt % of solvents selected from the group consisting of methanol, isopropyl alcohol, iso-butanol, hexanol, 2-ethyhexanol, aromatic solvents, propylene glycol, polyethylene glycol, glycerine, ester of fatty acid, vegetable oil, alcohol, propylene carbonate, glycerine carbonate, mineral oil, hydrocarbons, N-Methylpyrrolidone (NMP), amides and combinations thereof, wherein the method comprises mixing the alkylbenzene sulfonate salt with an effective amount of a liquid alcohol alkoxylate.

13. The method of claim 12 wherein:
(a) the liquid salt of alkylbenzene sulfonate is calcium or dimethylamidopropylamine salt of alkylbenzene sulfonate; and/or
(b) the alkyl group in the alkylbenzene sulfonate is C12-C14 linear or branched, saturate or non-saturated, substituted or non-substituted hydrocarbon group; and/or
(c) the liquid alcohol alkoxylate has the following structure:
R—O(CH2-CH2-O)ₙ—H
wherein R is C6-C10, linear or branched, hydrocarbon chain, for example a branched C8-C10 alkyl group, and n is from 1-8, for example 3-5.

14. The method of claim 12 wherein said composition is essentially free of additives.

15. The method of claim 12 wherein the concentration of the alkylbenzene sulfonate salt is from about 40-70 wt %, for example from about 55-60 wt %, and/or wherein the concentration of the liquid alcohol alkoxylate in the composition is from about 60-30 wt %.
